(19) United States
(12) Patent Application Publication
(10) Pub. No.: US 2016/0042178 A1
(43) Pub. Date: Feb. 11, 2016

(54) INFORMATION PROCESSING DEVICE

(71) Applicant: PANASONIC INTELLECTUAL PROPERTY MANAGEMENT CO., LTD., Osaka (JP)

(72) Inventors: Takeshi NINOMIYA, Osaka (JP); Yoshihide NAKASHIMA, Fukuoka (JP)

(73) Assignee: PANASONIC INTELLECTUAL PROPERTY MANAGEMENT CO., LTD., Osaka (JP)

(21) Appl. No.: 14/810,958

(22) Filed: Jul. 28, 2015

(30) Foreign Application Priority Data
Aug. 7, 2014 (JP) 2014-161860

(51) Int. Cl. G06F 21/55

(52) U.S. Cl. CPC G06F 21/55; G06F 2221/033

(57) ABSTRACT

In a payment terminal device, a plurality of APIs are called with the execution of a payment application, and have individual functions. Monitor statistics monitor a call procedure of APIs which are used with the execution of the payment application. A statistics accumulator accumulates a history of the call procedure of the APIs. A determiner determines the validity of the call procedure of the APIs monitored by the monitor statistics based on the call history of the APIs accumulated in the statistics accumulator.

### BACKGROUND OF THE INVENTION

1. Field of the Invention

The present disclosure relates to an information processing device capable of executing a plurality of processes.

2. Description of the Related Art

For example, in credit transactions of articles or services using credit cards, security of transactions is ensured by verifying (identity verification) whether or not a person who performs a transaction is the same person as an owner of a credit card which is used in the transaction. The identity verification is performed by a customer signing a transaction slip with a transaction content printed thereon at the time of a payment process of a transaction and a salesperson visually comparing the sign with a sign described in the credit card.

In recent years, a terminal device which can allow the input of the signature and display the signature is realized using a smartphone or a tablet terminal. Numerous smartphones or tablet terminals are distributed as customer devices and can be obtained at low cost to construct payment terminal devices. That is, if such payment terminal devices are constituted using numerous information terminals, such as smartphones or tablet terminals, which are distributed as customer devices, the payment terminal devices themselves can be obtained at low cost. Furthermore, since a development platform of applications (software) for use in the payment process and other business can be generalized, it becomes easy to reuse or utilize development property.

Information terminals designed for the use as customer devices are not provided with “temper resistance” necessary for securely performing transactions while protecting information of customers. The “temper resistance” is resistance to the attack of stealing information from the information terminals. U.S. Patent Publication No. 2010/0145854 and Japanese Patent Unexamined Publication No. 2004-355211 suggest mobile devices in which, in order to ensure temper resistance as a countermeasure to the attack of stealing information from the information terminals, a portion (in U.S. Patent Publication No. 2010/0145854, referred to as “secure part”; a portion provided with temper resistance necessary as a payment terminal device) related to authentication information of a card for use in a payment process is separated from a general-purpose portion.

However, in a payment terminal device which is used in a payment process, while security is ensured for a secure part, security is generally insufficient for a non-secure part. For this reason, when an unauthorized application is installed in the non-secure part, an authorized input area for inputting authentication information (for example, personal identification number (PIN) or signature) for identity verification is likely to be hidden illegally. Alternatively, another unauthorized input area is likely to be displayed by the unauthorized application. From such a situation, when a user misunderstands the unauthorized input area as an authorized input area and inputs authentication information to the unauthorized input area, the authentication information is likely to be taken away (phishing).

In a normal (normally operating) application, a plurality of application program interfaces (APIs) which are used at the time of the execution of the application are called according to a prescribed order with the execution of processes in the application. On the other hand, when an unauthorized application is installed, the call order of the APIs which are used at the time of the execution of the application is not as the prescribed order, and an unauthorized payment process may be performed.

### SUMMARY OF THE INVENTION

The present disclosure provides an information processing device which suppresses a process of a doubtful transaction or the like and ensures security of authentication information or the like by monitoring a call order of APIs used at the time of the execution of an application even when a secure part and a non-secure part coexists.

According to the present disclosure, there is provided an information processing device which is constituted of a non-secure first information processor and a secure second information processor and is capable of executing a plurality of processes, the information processing device including a plurality of individual functions which are used with the execution of the processes and have different individual functions, and a determiner which determines the validity of a use procedure of the individual functions based on a history of the use procedure of the individual functions, in which the determiner is mounted on the second information processor.

### BRIEF DESCRIPTION OF DRAWINGS

FIG. 1A is a diagram showing the overall configuration of a payment system including a payment terminal device of this embodiment.

FIG. 1B is a front view showing the appearance of the payment terminal device shown in FIG. 1A.

FIG. 2 is a block diagram showing an example of the functional internal configuration of the payment terminal device of this embodiment.

FIG. 3 is a diagram showing an example of various applications usable in the payment terminal device of this embodiment.

FIG. 4 is a diagram showing an example of the configuration of hardware of the payment terminal device of this embodiment.

FIG. 5 is a flowchart illustrating an operation to monitor a call procedure of APIs in the payment terminal device of this embodiment.

FIG. 6A is a diagram showing an example of an operation procedure of a payment process when a magnetic credit card is used and a call procedures of APIs is performed normally.

FIG. 6B is a diagram showing an example of an operation procedure of another payment process when a call procedure of APIs is performed normally.

FIG. 6C is a diagram showing an example of an operation procedure of a payment process when a call procedures of APIs is abnormal and fraud is suspected.

FIG. 7A is a diagram showing an example of an operation procedure of a payment process when an IC credit card is used and a call procedure of APIs is performed normally.

FIG. 7B is a diagram showing an example of an operation procedure of a payment process when a call frequency of an API is abnormal and fraud is suspected.

FIG. 7C is a diagram showing an example of an operation procedure of another payment process when a call frequency of an API is abnormal and fraud is suspected.

### DETAILED DESCRIPTION OF THE PREFERRED EMBODIMENT

Next, an embodiment of an information processing device according to the invention (hereinafter, referred to as “this embodiment”) will be described referring to the drawings. In this embodiment, as an example of the information processing device according to the invention, a payment terminal device which is used at the time of a payment process in a transaction of an article or a service is illustrated.

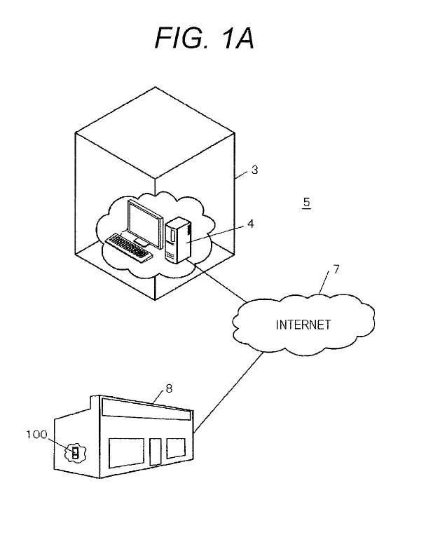

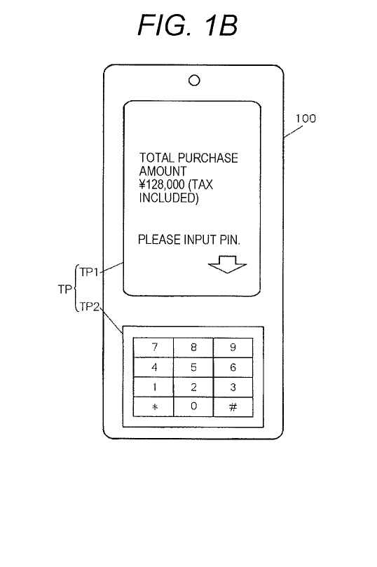

FIG. 1A is a diagram showing the overall configuration of payment system 5 including payment terminal device 100 of this embodiment. Payment system 5 performs a payment process in a transaction of an article or the like, and data processing device 4 provided in payment center 3 and payment terminal device 100 provided in each member store 8 are connected through Internet 7.

In a transaction of an article or the like, payment center 3 verifies whether or not a person who performs the transaction is the same person as an owner of a credit card or the like which is used in the transaction. At the time of the verification, the person (operator) who performs a transaction inputs a personal identification number (PIN) to payment terminal device 100.

Data processing device 4 of payment center 3 receives the PIN input to payment terminal device 100 through Internet 7 and compares the PIN with authentication information registered in a database in advance. As a result of comparison, when authentication is successful, payment center 3 provides credit to the operator of payment terminal device 100. If credit is provided from payment center 3, payment terminal device 100 proceeds a payment process.

FIG. 1B is a front view showing the appearance of payment terminal device 100 shown in FIG. 1A. Payment terminal device 100 is of portable type which can be held by the operator with the hand, and has touch panel TP on the operation surface thereof. Here, touch panel TP has two screens. Payment amount information and a message prompting the input. of the PIN are displayed on the screen of one touch panel TP1 (in the drawing, an upper side). A PIN pad is displayed on the screen of the other touch panel TP2 (in the drawing, a lower side). The operator touches the PIN pad with a pen to input the PIN.

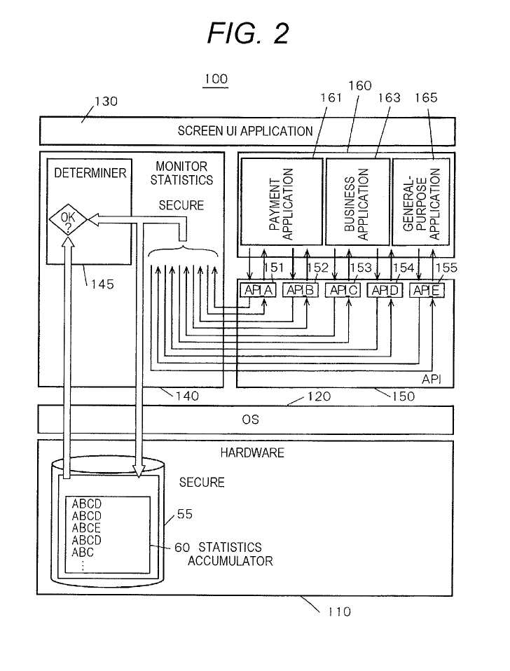

FIG. 2 is a block diagram showing an example of the functional internal configuration of payment terminal device 100 of this embodiment. Payment terminal device 100 includes hardware 110, operating system (OS) 120, API 150, application 160, monitor statistics 140 having determiner 145 described below, and screen UI application 130. Hardware 110 is provided with storage memory 55 in which statistics accumulator 60 is allocated to the storage area thereof. Monitor statistics 140 (including determiner 145) and statistics accumulator 60 are preferably mounted, for example, in a secure part (second information processor 41) described below for tempering prevention.

In statistics accumulator 60, as described below, a history of a procedure for calling application programming interface (APIs) for each application is accumulated. In FIG. 2, as the history of the procedure for calling the APIs, for example, “ABCD”, “ABCD”, “ABCE”, “ABCD”, “ABC”, . . . are accumulated. In the description of FIG. 2, “A”, “B”, “C”, “D”, and “E” indicate individual APIs.

In API 150, individual functions which are called from each application in application 160 are prepared. Then, the respective individual functions can call the programs of the individual functions through the APIs. An API is a program including an external application which assists the function of the application and has an individual function, and an interface which enables the use of the external application. The interface includes a specification in which a manner of calling or describing the external application, or the like is determined. In FIG. 2, for example, five APIs (API_A to API_E) 151 to 155 are shown.

Monitor statistics 140 (monitor) include determiner 145, and are a function which is realized when second CPU 42 in a secure part described below executes firmware (middleware) operating on OS 120.

When first CPU 22 executes an application (process), monitor statistics 140 monitor a procedure (a call procedure of the APIs) for each application to call the APIs from API 150, accumulates the call procedure in statistics accumulator 60, and transfers the call procedure to determiner 145. Here, the call procedure (use procedure) includes at least one of a call order (use order) of APIs and a call frequency (use frequency) of an API which are likely to appear as changes when an unauthorized application is executed. The call procedure may include the interval of call time of APIs or the like.

Determiner 145 determines the validity of the application, that is, whether or not an authorized application is executed, based on the call procedure (call order and call frequency) of the APIs received from monitor statistics 140 with reference to statistics accumulator 60.

For example, in FIG. 2, when it is understood that “ABCD” is normal based on the history of the call procedure accumulated in monitor statistics 140 as the call order of the API, determiner 145 determines that an authorized application is executed from the call order of the APIs monitored by monitor statistics 140. On the other hand, when the call order of the APIs is “ABCE” which is not performed in this application, determiner 145 determines that an unauthorized application is executed. In addition, when the call order of the APIs is “ABC”, determiner 145 determines that a transaction is likely to be stopped halfway and determines that an application is a doubtful application (an application of a gray zone). In the case of a doubtful application, the operator can arbitrarily select a subsequent process.

Here, in the determination about whether or not the call order is normal, the history of the call order accumulated in statistics accumulator 60 for each application is used. For example, when the monitored call order is the same as many call orders accumulated as a history, determiner 145 determines that the monitored call order is normal. Conversely, in the case of a rare call order, determiner 145 determines that the monitored call order is abnormal. This is based on the view that many normal transaction processes are performed in the call order of the highest frequency.

When the call frequency of many APIs accumulated as a history is a maximum of three times (an example), if the monitored call frequency is within three times, determiner 145 determines that the monitored call frequency is normal, and if the monitored call frequency is equal to or greater than four times, determiner 145 determines that the monitored call frequency is abnormal.

Here, although the validity of the call procedure is determined according to whether or not the call procedure is the same as many call procedures accumulated in statistics accumulator 60 as a history, that is, whether or not there are many histories, a validity determination method is not limited thereto. For example, a call procedure by an unauthorized application may be registered in the statistics accumulator in advance, and when a monitored call procedure is the same as the registered call procedure, the determiner may determine that the monitored call procedure is abnormal. Alternatively, a call procedure by a normal application may be registered in the statistics accumulator in advance, and when a monitored call procedure is the same as the registered call procedure, the determiner may determine that the monitored call procedure is normal. In this way, determiner 145 may determine validity according to whether or not a monitored call procedure complies with a call procedure determined in advance.

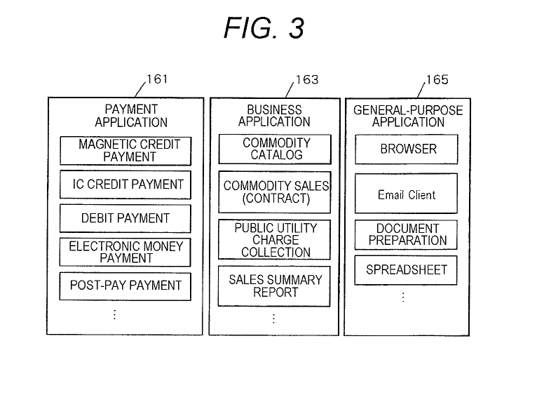

In application 160, various applications are installed. Various applications shown in FIG. 2 are broadly classified into three applications of payment application 161, business application 163, and general-purpose application 165. FIG. 3 is a diagram showing an example of various applications usable in payment terminal device 100 of this embodiment. Payment application 161 includes a magnetic credit payment application, an IC credit payment application, a debit payment application, an electronic money payment application, a post-pay payment application, and the like.

Business application 163 includes a commodity catalog application, a commodity sales (contract) application, a public utility charge collection application, a sales summary report application, and the like.

General-purpose application 165 includes a browser application, an Email Client application, a document preparation application, a spreadsheet application, and the like.

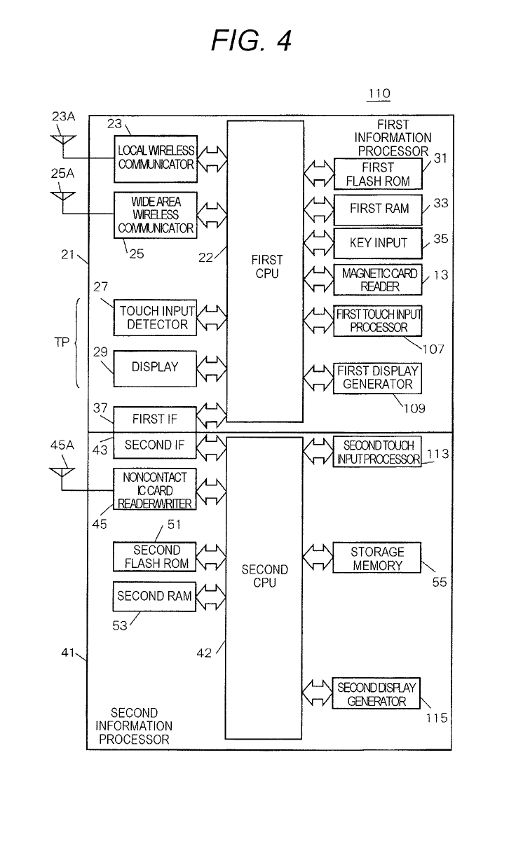

FIG. 4 is a diagram showing an example of the configuration of hardware 110 of payment terminal device 100 of this embodiment. Hardware 110 of payment terminal device 100 includes first information processor 21 and secure second information processor 41. First information processor 21 includes first central processing unit (CPU) 22, local wireless communicator 23, wide area wireless communicator 25, display 29, and touch input detector 27.

First information processor 21 includes first flash read only memory (ROM) 31, first random access memory (RAM) 33, key input 35, magnetic card reader 13, and first interface (IF) 37.

First information processor 21 includes first touch input processor 107 and first display generator 109.

In first information processor 21, the respective parts are connected to first CPU 22. First CPU 22 controls entire first information processor 21, and performs, for example, various kinds of control, processes, settings, determination, decision, verification, and the like.

Local wireless communicator 23 is connected to local wireless communication antenna 23A, and has a function of performing, for example, wireless LAN communication using a local wireless communication path (not shown). Local wireless communicator 23 may perform communication (for example, Bluetooth (Registered Trademark) communication) other than wireless LAN communication.

Wide area wireless communicator 25 is connected to wide range wireless communication antenna 25A, and has a function of performing communication through a wide range wireless communication path (not shown) (for example, wide area network (WAN)). Communication in the wide area wireless communication path may be performed using, for example, mobile communication, such as wideband code division multiple access (W-CDMA), universal mobile telecommunications system (UMTS), code division multiple access (CDMA) 2000, or long term evolution (LTE).

Touch panel TP has a structure in which a detection surface of touch input detector 27 and a screen of display 29 are superimposed. In this embodiment, touch panel TP is divided into two touch panels of touch panel TP1 and touch panel TP2. On the screen of touch panel TP1, a non-secure display area and a secure display area are set. On the detection surface of touch panel TP1, a non-secure input area is set. In addition, on the screen of touch panel TP2, a secure display area is set. On the detection surface of touch panel TP2, a non-secure input area is set. Display 29 has a function of controlling display of touch panel TP (see FIG. 1B). Touch input detector 27 has a function of detecting a touch input on touch panel TP.

First flash ROM 31 has a function of storing various kinds of data. In first flash ROM 31, various applications, such as payment application 161, business application 163, and general-purpose application 165 described above, are stored so as to be updateable. In addition, in first flash ROM 31, a program for first information processor 21 is stored.

First RAM 33 is a memory which is used to temporarily store process data generated in the middle of a calculation process, for example, at the time of a calculation process accompanied with the operation of first information processor 21.

Key input 35 has a function of receiving an input from input keys (not shown) arranged on the side surface or the like of a housing. Magnetic card reader 13 is partially arranged inside a slit, and has a function of reading a magnetic stripe of a magnetic card.

First touch input processor 107 performs a process corresponding to an operation (pen input or the like) input in the non-secure input area. First display generator 109 generates image data which is displayed in the non-secure display area.

First information processor 21 and second information processor 41 are connected to each other through first interface (hereinafter, referred to as first IF”) 37 and second interface (hereinafter, referred to as “second IF”) 43, and delivery of various kinds of data or commands is performed therebetween. In addition, first IF 37 and second IF 43 can be interconnected.

Second information processor 41 is a secure part, and includes second IF 43, second CPU 42, non-contact IC card reader/writer 45, second flash ROM 51, second RAM 53, second touch input processor 113, second display generator 115, and storage memory 55.

In second information processor 41, the respective parts are connected to second CPU 42. Second CPU 42 controls entire second information processor 41, and performs various kinds of control, processes (for example, a payment process), settings, determination, decision, verification, authentication, comparison (for example, comparison of PIN or signature), and the like.

Second flash ROM 51 has a function of storing various kinds of data. In addition, in second flash ROM 51, in addition to various kinds of data, a program for controlling second information processor 41 is stored.

Second RAM 53 is a memory which is used to temporarily store process data generated in the middle of a calculation process, for example, at the time of a calculation process or the like accompanied with the operation of second information processor 41.

Noncontact IC card reader/writer 45 has loop antenna 45A, is provided in second information processor 41 which is a secure part, and controls the input/output of an IC card.

Second touch input processor 113 performs a process corresponding to an operation (pen input or the like) input in the secure input area. Second display generator 115 generates image data which is displayed in the secure display area.

Storage memory 55 is a memory, such as a solid state drive (SSD), capable of storing data for a long period, and statistics accumulator 60 is allocated to part of the storage area thereof.

The operation of payment terminal device 100 having the above-described configuration will be described below. Here, a case of monitoring a call procedure for calling APIs with the execution of the payment application will be described.

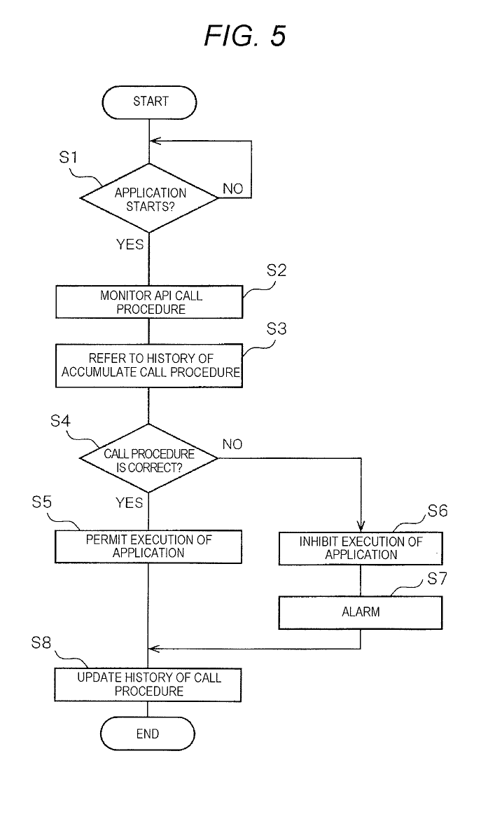

FIG. 5 is a flowchart illustrating an operation to monitor a call procedure of APIs in payment terminal device 100 of this embodiment.

In FIG. 5, first, it waits until the process of the payment application 161 is started (S1). If the process of the payment application 161 is started, monitor statistics 140 monitors a call procedure of APIs which are called by payment application 161 (S2). Here, as the call procedure, a call order is monitored. Monitor statistics 140 transfers the monitoring result of the call order of the APIs to determiner 145.

Determiner 145 refers to a history of the call procedure accumulated in the statistics accumulator 60 (S3). Determiner 145 reads a call order of APIs which are called with the execution of authorized payment application 161 from the history of the call procedure accumulated in statistics accumulator 60. Here, as described above, it is assumed that a call order accumulated the most among the call orders of each application accumulated in statistics accumulator 60 is a normal call order.

Determiner 145 determines whether or not the monitored call order of the APIs matches the accumulated call order of the APIs (S4). A call frequency may be used instead of the call order, both the call order and the call frequency may be used, or another call procedure may be used. When the monitored call order matches the accumulated call order, determiner 145 permits the execution of the payment application (S5). On the other hand, when the monitored call order does not match the accumulated call order, determiner 145 stops the execution of the payment application (S6), and issues a warning (S7). Here, although a message for attracting attention is displayed on the screen of the touch panel TP as a warning, sound may be emitted.

After the execution of the payment application is permitted in Step S5, or when the warning is issued in Step S7, monitor statistics 140 accumulates the monitored call procedure of the APIs in statistics accumulator 60, and updates the history of the call procedure of the APIs accumulated in the statistics accumulator 60 (S8). Therefore, this operation ends.

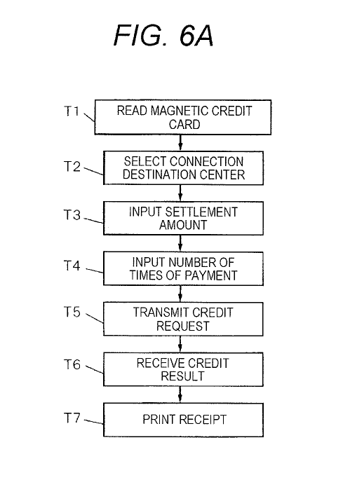

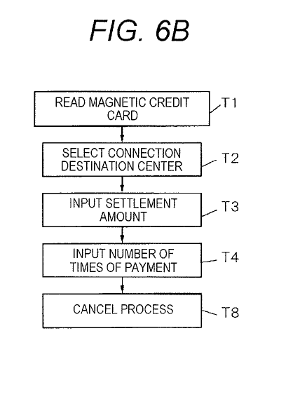

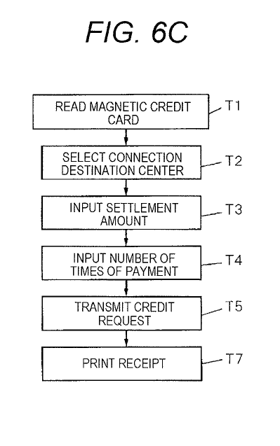

A specific example of a call procedure of APIs is shown. FIG. 6A shows an example of an operation procedure of a payment process when a magnetic credit card is used and a call procedure of APIs is performed normally. Payment application 161 first calls an API which reads the magnetic credit card (T1), and causes the operator to perform a read operation of the magnetic credit card.

Payment application 161 calls an API which selects a connection destination center (T2), and selects a connection destination center corresponding to the brand of the read magnetic credit card. When the read magnetic credit card has a plurality of card brands, payment application 161 selects a connection destination center corresponding to a card brand selected by the operator from among a plurality of card brands. Payment application 161 calls an API which inputs a payment amount (T3), and causes the operator to input a payment amount.

Payment application 161 calls an API which inputs the number of payments (T4), and causes the operator to input the number of payments. Payment application 161 calls an AP which requests credit to the connection destination center selected in the procedure T2 (T5), and transmits a credit request to the connection destination center.

Payment application 161 calls an API which receives the credit request from the connection destination center (T6), and receives the result of credit. If credit is added, payment application 161 calls an API which performs a payment process and prints a receipt (T7), and prints a receipt.

FIG. 6B shows an example of an operation procedure of another payment process when a call procedure of APIs is performed normally. After the procedure T4 for calling the API which inputs the number of payments, payment application 161 calls an API which receives a cancel operation from the operator to cancel the payment process (T8), and cancels this payment process.

FIG. 6C shows an example of an operation procedure of a payment process when a call procedure of APIs is abnormal and fraud is suspected. A payment application shown in FIG. 6C where fraud is suspected calls the API, which prints a receipt, in the procedure T7 after transmitting the credit request in the procedure T5 without receiving the credit result from the connection destination center. Compared to FIG. 6A, a receipt is printed without receiving the credit result. In this way, a payment application which is not accompanied with the reception of the credit result as if it is known beforehand that credit is not provided is determined to be an unauthorized application.

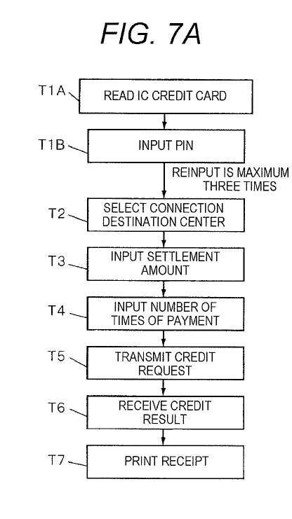

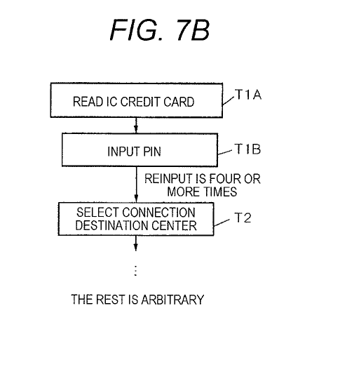

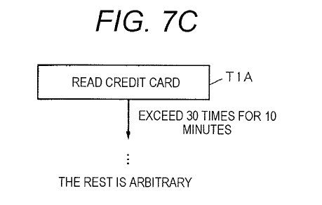

FIG. 7A shows an example of an operation procedure of a payment process when an IC credit card is used and a call procedure of APIs is performed normally. Payment application 161 first calls an API which reads the IC credit card (T1A), and causes the operator to perform a read operation of the IC credit card.

Payment application 161 calls an API which processes a PIN input (T1B), and receives a PIN input from the operator. In this API, the reinput of the PIN is limited to a maximum of three times. The three times as the limit value may be registered in advance, or may be automatically set from a past history. Thereafter, the call procedure of the APIs is performed in the same manner as in FIG. 6A.

FIG. 7B shows an example of an operation procedure of a payment process when a call frequency of an API is abnormal and fraud is suspected. An application where fraud is suspected calls the API, which receives the PIN input, four or more times. When it is determined that the call procedure of the APIs is abnormal, the execution of the application is stopped. The process is not limited to stopping, and an arbitrary process may be performed.

FIG. 7C shows an example of an operation procedure of another payment process when a call frequency of an API is abnormal and fraud is suspected. That is, an application where fraud is suspected calls an API, which reads a card, multiple times for a short period (in this case, over 30 times for ten minutes). In this case, it is assumed that an unauthorized payment by an owner of a forged card or a third person other than an authorized owner of a card is performed multiple times for a short period. When it is determined that the call of the API is abnormal, similarly, the execution of the application is stopped. The process is not limited to stopping, and an arbitrary process may be performed.

With the above, in payment terminal device 100 of this embodiment, a plurality of APIs 151 to 155 are called with the execution of payment application 161, and have the individual functions. Monitor statistics 140 monitor the call procedure of the APIs which are called with the execution of payment application 161. Statistics accumulator 60 accumulates the history of the call procedure of the APIs. Determiner 145 determines the validity of the call procedure of the APIs monitored by the monitor statistics 140 based on the history of the call procedure of the APIs accumulated in statistics accumulator 60.

With this, when it is determined that the call procedure of the APIs is abnormal, payment terminal device 100 can stop the execution of payment application 161. Therefore, even when a secure part and a non-secure part coexist, it is possible to suppress a process, such as a doubtful transaction, by monitoring a call order of APIs which are used at the time of the execution of an application, whereby it is possible to ensure security of authentication information or the like. In particular, it is possible to ensure security of an input PIN. In addition, payment terminal device 100 can reduce damage (for example, steal or falsification of PIN or signature, or unauthorized transaction) to a member store or an acquirer caused by unauthorized behavior of a malicious application.

Since a monitored call procedure includes at least one of a call order and a call frequency of APIs which are likely to appear as changes when an unauthorized application is executed, payment terminal device 100 can easily find a process by an unauthorized application.

Since payment terminal device 100 can stop the execution of an application when a call procedure of APIs is abnormal, it is possible to prevent an unauthorized application from being continuously performed.

Since payment terminal device 100 can issue a predetermined warning when a call procedure of APIs is abnormal, it is possible to make the operator aware of the execution of a process by an unauthorized application.

Since payment terminal device 100 permits the execution of a process by an application when a call procedure is normal, it is possible to continue the execution of a process by an application desired by the operator.

Since payment terminal device 100 accumulates a monitored call procedure in the statistics accumulator, it is possible to update a history of a call procedure of APIs to the latest state.

Although various embodiments have been described referring to the drawings, the invention is not limited to the embodiments. It is obvious to those skilled in the art that various changes or corrections may be made within the scope described in the appended claims, and it is understood that the changes or correction still fall within the technical scope of the invention.

For example, in the foregoing embodiment, although application programming interfaces (API) which are called by an application has been illustrated as individual functions, hardware resources having individual functions, such as timers, counters, and printers, may be used.

What is claimed is:

1. An information processing device which is constituted of a non-secure first information processor and a secure second information processor and is capable of executing a plurality of processes, the information processing device comprising:
a plurality of individual functions which are used with the execution of the processes and have different individual functions; and
a determiner which determines the validity of a use procedure of the individual functions based on a history of the use procedure of the individual functions,
wherein the determiner is mounted on the second information processor.

2. The information processing device of claim 1,
wherein the use procedure of the individual functions includes at least one of a use order and a use frequency of the individual functions.

3. The information processing device of claim 1,
wherein the determiner stops the execution of the processes when it is determined that the use procedure of the individual functions is abnormal.

4. The information processing device of claim 3,
wherein the determiner issues a predetermined warning when it is determined that the use procedure of the individual functions is abnormal.

5. The information processing device of claim 1,
wherein the determiner permits the execution of the process when it is determined that the use procedure of the individual functions is normal.

6. The information processing device of claim 1,
wherein the determiner accumulates the use procedure of the individual functions in an accumulator, and updates the history of the use procedure of the individual functions accumulated in the accumulator.

7. The information processing device of claim 1,
wherein the information processing device is of portable type.
